(19) United States
(12) Patent Application Publication
(10) Pub. No.: US 2003/0035681 A1
(43) Pub. Date: Feb. 20, 2003

(54) Document holder

(76) Inventor: Chin-Lien Ho, Taichung City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 09/932,134

(22) Filed: Aug. 20, 2001

(51) Int. Cl. B42F 3/00; B42F 13/02

(52) U.S. Cl. 402/8

(57) ABSTRACT

A document holder includes a case body having an elongate base part, and first and second casing parts. The elongate base part has opposite longitudinal edges, a bottom surface, and a top surface. The top surface is mounted with a ring binder unit that is adapted for binding removably loose-leaf document holding sheets. Each of the first and second casing parts has an outer casing surface, a recessed inner casing surface opposite to the outer casing surface, and a hinge edge connected pivotally to a respective one of the longitudinal edges of the base part such that the first and second casing parts are movable between folded and unfolded positions relative to the base part.

### BACKGROUND OF THE INVENTION

1. Field of the Invention

The invention relates to a document holder, more particularly to a document holder with a ring binder unit for receiving a large number of documents in an orderly manner.

2. Description of the Related Art

Referring to FIGS. 1 and 2, a conventional document holder 1 is shown to comprise an elongate curved base part 112, front and rear wall parts 111, 113, a pair of lateral wall parts 115, and a cover part 114. The front and rear edges 1121, 1122 of the base part 112 extend in a longitudinal direction, and are spaced apart in a transverse direction transverse to the longitudinal direction. Each of the front and rear wall parts 111, 113 extends upwardly from a respective one of the front and rear edges 1121, 1122 of the base part 112. The lateral wall parts 115 are spaced apart in the longitudinal direction, and are formed with a plurality of pleats 1153. Each of the lateral wall parts 115 further extends in the transverse direction, has opposite ends 1151, 1152 connected respectively to the front and rear wall parts 111, 113, and cooperates with the front and rear wall parts 111, 113 to confine a document holding space 117 with an open top. A plurality of partition plates 1154 extend in the longitudinal direction, and have opposite ends connected respectively to the lateral wall parts 115. The partition plates 1154 cooperate with the lateral wall parts 115 to divide the document holding space 117 into a plurality of volume variable spaces. The cover part 114 is hinged to a top edge 1131 of the rear wall part 113, and is movable between a closed position, where the cover part 114 covers the open top of the document holding space 117, as best illustrated in FIG. 1, and an open position, where the cover part 114 uncovers the open top of the document holding space 117, as best shown in FIG. 2.

In use, when the cover part 114 is moved to the open position, documents can be placed in and removed from the volume variable spaces of the document holding space 117. After use, the cover part 114 is moved to the closed position so as to cover the open top of the document holding space 117.

It is noted that the configuration of the volume variable spaces of the conventional document holder 1 results in a limited number of documents that can be received in the conventional document holder 1. Furthermore, the conventional document holder 1 has no space allocated for receiving accessories, such as pens, coins, cellular phones, etc.

### SUMMARY OF THE INVENTION

Therefore, the main object of the present invention is to provide a document holder that is capable of overcoming the aforementioned drawbacks of the prior art.

Accordingly, a document holder of this invention comprises a case body that includes an elongate base part, and first and second casing parts. The elongate base part has opposite longitudinal edges, an outer base surface, and an inner base surface opposite to the outer base surface. The inner base surface is mounted with a ring binder unit that is adapted for binding removably loose-leaf document holding sheets. Each of the first and second casing parts has an outer casing surface, and a recessed inner casing surface opposite to the outer casing surface. Each of the first and second casing parts further has a hinge edge connected pivotally to a respective one of the longitudinal edges of the base part such that the first and second casing parts are movable between a folded position and an unfolded position. In the folded position, the inner casing surfaces of the first and second casing parts confront each other. In the unfolded position, the inner casing surfaces of the first and second casing parts are spread apart from each other.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional document holder;

FIG. 2 is another perspective view of the document holder of FIG. 1;

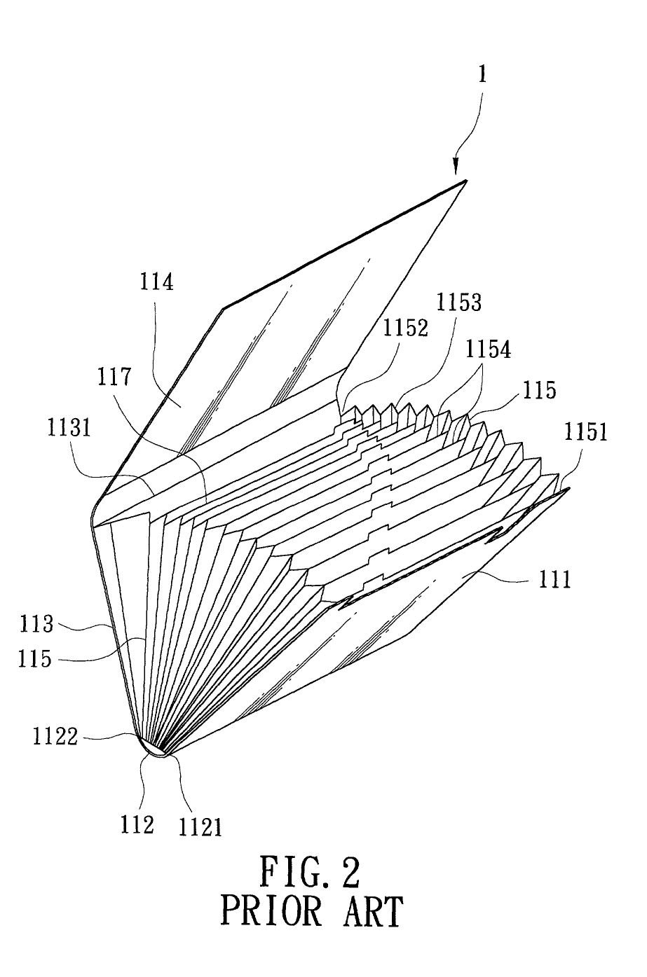

FIG. 3 is a partly exploded perspective view of the preferred embodiment of a document holder according to the present invention;

FIG. 4 is a perspective view of the document holder of FIG. 3 in an unfolded state;

FIG. 5 is a schematic view of the document holder of FIG. 3 in an unfolded state;

FIG. 6 is a schematic view of the document holder of FIG. 3 in a folded state; and

FIG. 7 is a perspective view of the document holder of FIG. 3 to illustrate another use of the preferred embodiment of the present invention.

### DETAILED DESCRIPTION OF THE PREFERRED EMBODIMENT

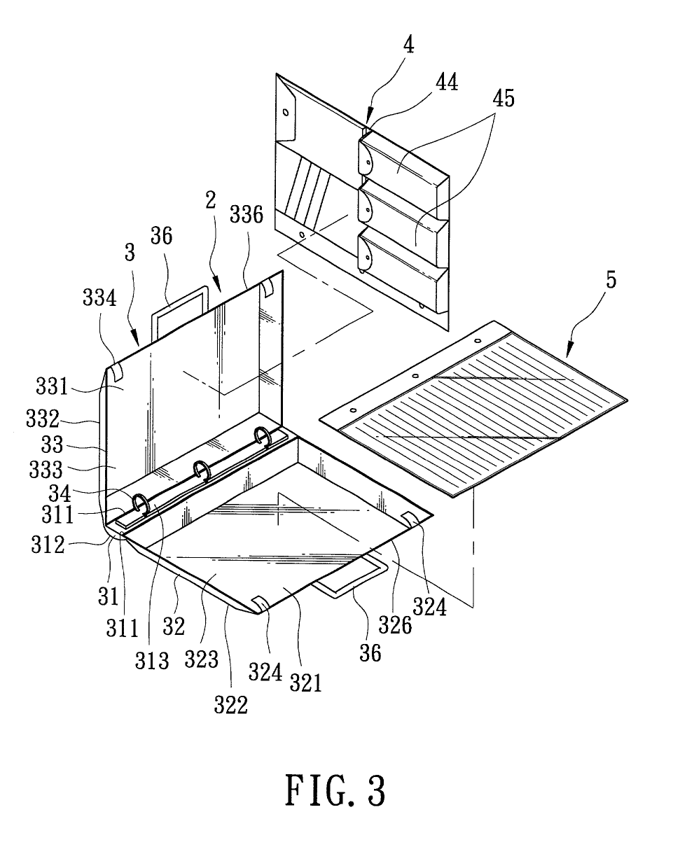

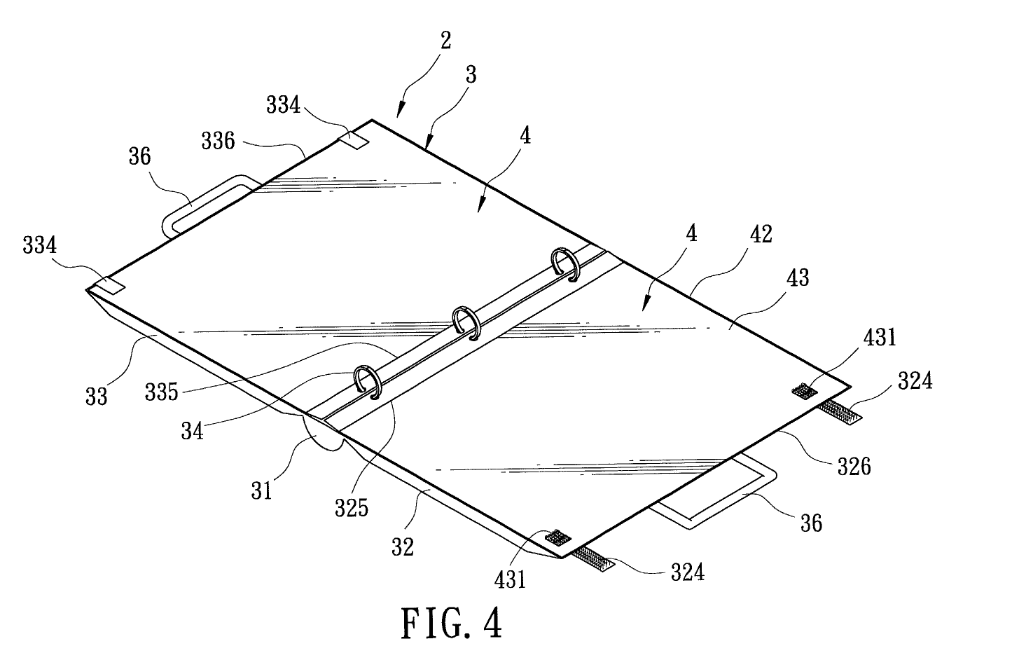

Referring to FIGS. 3 and 4, the preferred embodiment of a document holder 2 according to the present invention is shown to comprise a case body 3 that includes an elongate base part 31 and first and second casing parts 32, 33, and two rigid panel members 4. The elongate base part 31 has opposite longitudinal edges 311, an outer base surface 312, and an inner base surface 313 opposite to the outer base surface 312. The inner base surface 313 is mounted with a ring binder unit 34 that is adapted for binding removably loose-leaf document holding sheets 5 (only one is shown in FIG. 3). Since the ring binder unit 34 is known in the art, a detailed description of its binding principle will be dispensed with herein for the sake of brevity.

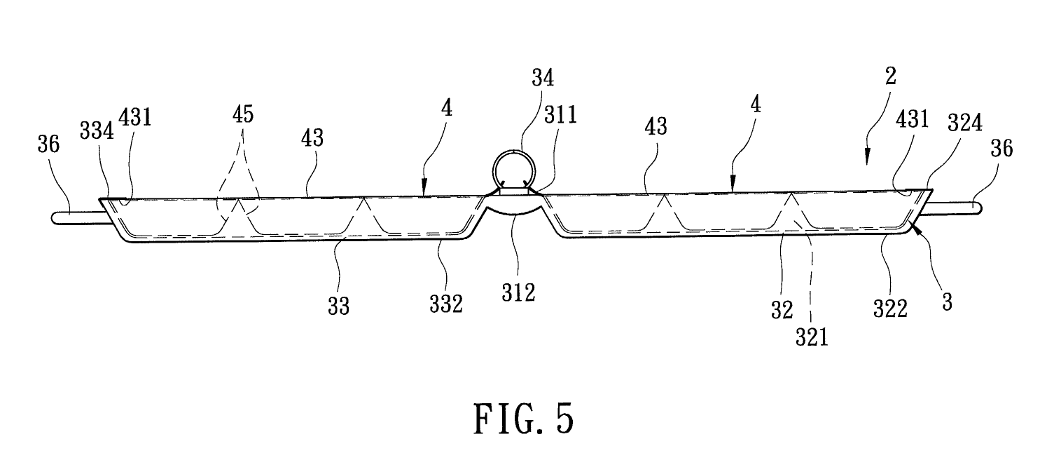

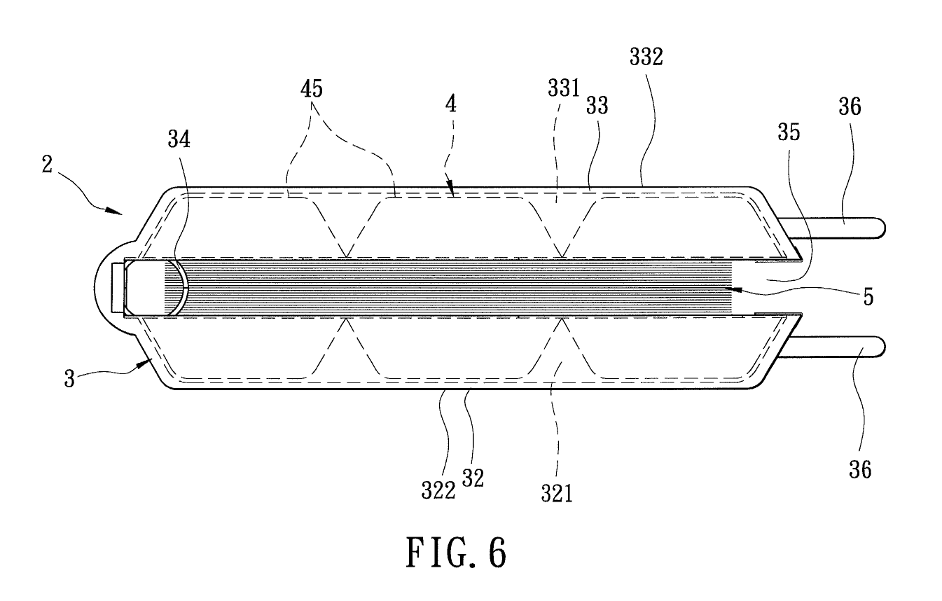

Each of the first and second casing parts 32, 33 has an outer casing surface 322, 332, a recessed inner casing surface 321, 331 opposite to the outer casing surface 322, 332, a hinge edge 325, 335, and a handling edge 326, 336 opposite to the hinge edge 325, 335. The hinge edge 325, 335 is connected pivotally to a respective one of the longitudinal edges 311 of the base part 31 such that the first and second casing parts 32, 33 are movable between a folded position and an unfolded position. In the folded position, the inner casing surfaces 321, 331 of the first and second casing parts 32, 33 confront each other, as shown in FIG. 6. In the unfolded position, the inner casing surfaces 321, 331 of the first and second casing parts 32, 33 are spread apart from each other such that the outer casing surfaces 322, 332 can be placed on a table surface, as best illustrated in FIGS. 4 and 5. The handling edge 326, 336 is formed with a handle 36 thereon. Furthermore, the first and second casing parts 32, 33 cooperate to form a document receiving space 35.

The panel members 4 are bound removably to the ring binder unit 34 of the base part 31. Each of the panel members 4 is movable on the ring binder unit 34 toward the inner casing surface 321, 331 of a respective one of the first and second casing parts 32, 33 to a covering position such that a flat side 42 of each of the panel members 4 can serve as a support for writing. The other side 44 of each of the panel members 4 is provided with a number of accessory pouches 45. The accessory pouches 45 of each of the panel members 4 extend into the inner casing surface 321, 331 of the respective one of the first and second casing parts 32, 33, and are configured to receive pens, keys, coins, cellular phones, etc. Female hook-and-loop fasteners 431 are provided on the flat side 42 of each of the panel members 4 for connecting with male hook-and-loop fasteners 324, 334 on the respective one of the first and second casing parts 32, 33 for retaining removably each of the panel members 4 in the covering position.

In use, the first and second casing parts 32, 33 are pulled apart, and the loose-leaf document holding sheets 5 are then bound on the ring binder unit 34 between the panel members 4. To put or retrieve accessories in the pouches 45 of one of the panel members 4, the male fasteners 324, 334 on one of the first and second casing parts 32, 33 are detached from the female fasteners 431 on one of the panel members 4.

It should be noted that the accessory pouches 45 of each of the panel members 4 extend into the inner casing surface 321, 331 of the respective one of the first and second casing parts 32, 33 when the first and second casing parts 32, 33 are folded. As such, the presence of the accessory pouches 45 does not affect the capacity of the document holding space 35 of the document holder 2. Thus, the document holder 2 is not only capable of receiving more documents, but is capable of receiving accessories as well. Furthermore, with the handle 36 provided on each of the first and second casing parts 32, 33, the document holder 2 can be easily carried by the user.

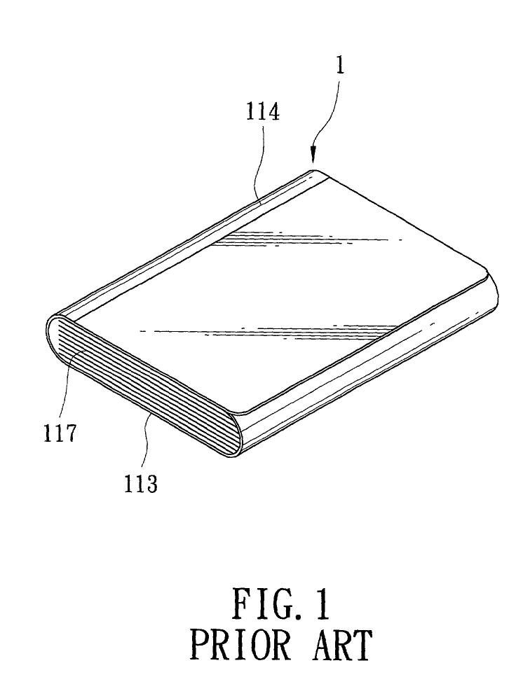

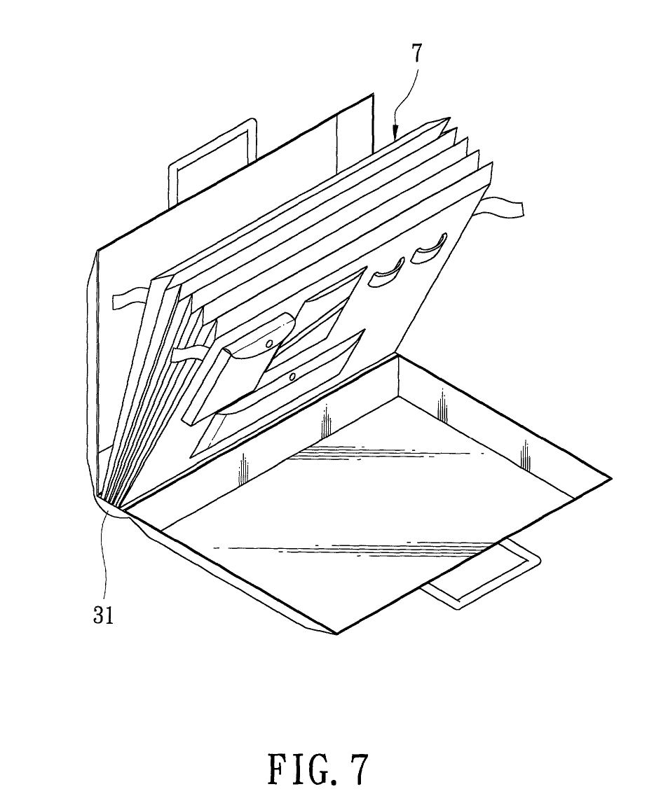

Another use of the preferred embodiment is shown in FIG. 7. The ring binder unit 34 is removed from the base part 31, and a conventional document holder 7 similar to that shown in FIG. 1 is retained on the base part 31 instead.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A document holder comprising a case body that includes:
an elongate base part having opposite longitudinal edges, an outer base surface, and an inner base surface opposite to said outer base surface and mounted with a ring binder unit adapted for binding removably loose-leaf document holding sheets; and
first and second casing parts, each of which has an outer casing surface and a recessed inner casing surface opposite to said outer casing surface, each of said first and second casing parts further having a hinge edge connected pivotally to a respective one of said longitudinal edges of said base part such that said first and second casing parts are movable between a folded position, where said inner casing surfaces of said first and second casing parts confront each other, and an unfolded position, where said inner casing surfaces of said first and second casing parts face are spread apart from each other.

2. The document holder as claimed in claim 1, further comprising at least one rigid panel member bound removably to said ring binder unit, said panel member being movable on said ring binder unit toward said inner casing surface of one of said first and second casing parts to a covering position such that one side of said panel member can serve as a support for writing.

3. The document holder as claimed in claim 2, further comprising interlocking male and female fasteners provided on said panel member and said one of said first and second casing parts for retaining removably said panel member in the covering position.

4. The document holder as claimed in claim 1, further comprising at least one panel member bound removably to said ring binder unit, said panel member having one side provided with at least one accessory pouch, and being movable on said ring binder unit toward said inner casing surface of one of said first and second casing parts to a covering position such that said accessory pouch extends into said recessed inner casing surface of said one of said first and second casing parts.

5. The document holder as claimed in claim 4, further comprising interlocking male and female fasteners provided on said panel member and said one of said first and second casing parts for retaining removably said panel member in the covering position.

6. The document holder as claimed in claim 1, wherein each of said first and second casing parts further has a handling edge opposite to said hinge edge and formed with a handle thereon.
